(19) United States
(12) Patent Application Publication
(10) Pub. No.: US 2008/0108307 A1
(43) Pub. Date: May 8, 2008

(54) METHOD AND RELATED APPARATUSES FOR AUTOMATICALLY CONTROLLING TARGET DEVICES

(75) Inventor: Iang-Chyi Yeh, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/758,698

(22) Filed: Jun. 6, 2007

(30) Foreign Application Priority Data
Nov. 6, 2006 (TW) 95140954

(51) Int. Cl. H04B 7/005

(52) U.S. Cl. 455/41.2

(57) ABSTRACT

A control method for automatically controlling a target device is provided. The method comprises the following steps. First, present position information is acquired according to a locating signal. Next, the present position information and position information of the target device are compared to determine whether the target device is being approached. Then, a control signal corresponding to the target device is found if the target device is being approached. Finally, the target device is controlled by sending the control signal thereto.

### BACKGROUND OF THE INVENTION

1. Field of the Invention

The invention relates to method and apparatus for automatically controlling target devices, and more particularly, to a control method and apparatus associated with a GPS (Global Positioning System) signal locating module or a Bluetooth communication module.

2. Description of the Related Art

Various devices, such as a security door or a car door can be controlled by a corresponding remote control. Each device to be controlled requires a specific remote control capable of sending specific frequencies or control signals to the device for controlling operation of the device. For example, a dedicated remote control must be utilized to open or close a security door when approaching the door. Similarly, a dedicated remote control must be utilized to lock or unlock a car door when approaching the car. Thus, controlling various devices requires a variety of remote controls dedicated to specific devices. Locating a specific remote control for a specific device may be complicated and time consuming.

### BRIEF SUMMARY OF THE INVENTION

The invention provides a method for automatically controlling a target device. First, present position information is acquired according to a locating signal. It is determined whether the target device is being approached by comparing the present position information and position information of the target device. A control signal is found corresponding to the target device if the target device is being approached, and the target device is controlled by sending the control signal thereto.

The invention also provides a control apparatus for controlling a target device. The control apparatus comprises a locating module, a processing unit, a storage unit and a transmission unit. The locating module acquires present position information. The processing unit compares the present position information and the position information of the target device. The storage unit stores the position information of the target device and a control signal corresponding thereto. The transmission unit transmits the control signal to control the target device. The processing unit drives the transmission unit to transmit the control signal to control the target device if a match between the present position information and the position information of the target device is found in the storage unit.

### BRIEF DESCRIPTION OF THE DRAWINGS

The invention can be more fully understood by reading the subsequent detailed description and examples with reference to the accompanying drawings, wherein:

FIG. 1 shows an embodiment of a control apparatus for controlling a target device according to the invention;

FIG. 2 is a flowchart of a control method according to an embodiment of the invention;

FIG. 3 is a flowchart of setting the position information of the target device according to an embodiment of the invention;

FIG. 4 is a flowchart of a control method for controlling the target device according to another embodiment of the invention;

FIG. 5 is a flowchart of a control method for controlling the target device according to yet another embodiment of the invention; and

FIG. 6 is a flowchart of a control method for controlling the target device according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a control apparatus and a control method for automatically controlling a target device. A position information of the target device can be acquired by a locating module or a wireless module within the control apparatus, and the position information is then recorded and associated with a control information capable of controlling the target device, such as a control frequency or an identification number of a physical remote control, in a storage unit of the control apparatus. If the control information corresponding to a present position information is found, a control signal is transmitted to the target device according to the control information for controlling the target device. GPS (global positioning system) is widely used to determine the relative distance between the device and positioning satellites for acquiring the position information of a device. Thus, the position information of a device or present position information can be acquired by a locating module, such as a GPS receiver, comprising a GPS signal-locating module that receives the GPS signal from the positioning satellites.

According to the invention, all position information and control information of the target devices is first recorded. Each recorded target device corresponds to a position information and a control information. When one of the target devices is approached, a control signal is transmitted according to the control information corresponding to the target device found in a storage unit according to the present position information. Thus, the target device is automatically controlled.

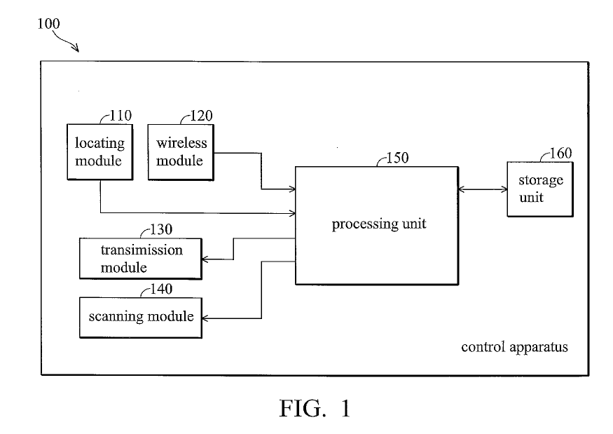

FIG. 1 shows an embodiment of a control apparatus 100 for controlling a target device according to the invention. The control apparatus 100 comprises a locating module 110, a wireless module 120, a transmission unit 130, a scanning module 140, a processing unit 150 and a storage unit 160. The locating module 110 receives a GPS locating signal for acquiring position information. The wireless module 120 is capable of performing wireless communication with the target device, and sending authentication information to the target device for authentication. The wireless module 120 may be a Bluetooth communication module capable of performing a Bluetooth based communication between two of Bluetooth devices or a microwave module transmitting a specific frequency. The transmission unit 130 transmits a control signal to control the target device. The scanning module 140 scans the control signal of the target device to acquire the control frequency corresponding to the target device. The transmission unit 130 may be implemented by a dual-frequency signal generator or may be formed by a plurality of the physical remote controls. The processing unit 150 checks the position information acquired by the locating module 110 or the authentication information received by the wireless module 120. The storage unit 160 stores the position information of the target device and a control information (control signal) corresponding thereto in a record. The processing unit 150 drives the transmission unit 130 to transmit a control signal by a control frequency corresponding thereto to control the target device if a match is found between the present position information and the position information of the target device in the storage unit 160. In this embodiment, the control apparatus is a PDA (personal digital assistant) including the GPS signal-locating module, and the control signal is a dual-frequency signal.

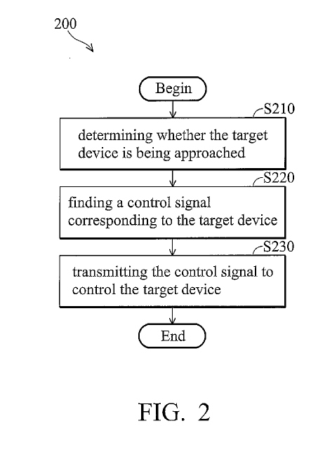

FIG. 2 is a flowchart of a control method according to an embodiment of the invention. It is first determined whether a target device is being approached by using a locating module or a wireless module in step S210. If the locating module is utilized, a locating signal is acquired first. Present position information is then obtained accordingly, and the present position information is compared to a position information of the target device to determine whether the target device is approached. Alternatively, if the wireless module is utilized, the wireless module 120 is enabled and determines that the target device is being approached if the wireless module 120 detects the target device. A control signal corresponding to the target device is then found when approaching the target device in step S220. The control signal is then transmitted to the target device for controlling the target device, such as locking or unlocking a car door in step S230. It is to be understood that the control signal, which is capable of controlling the target device, in addition to the control frequency, may comprise any other control information commonly used in a physical remote control (such as a specific identification code). Thus, although a control frequency is used to illustrate the invention, it is to be understood that the invention is not limited thereto. To the contrary, it is intended to cover various modifications and similar arrangements as would be apparent to the skilled in the art.

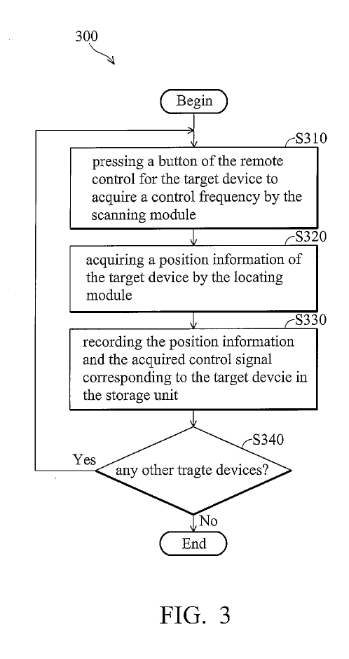

FIG. 3 is a flowchart of setting the position information of the target device according to an embodiment of the invention. A button of the remote control for the target device is pressed, and the scanning module within the transmission unit of the control apparatus then scans the transmission frequency transmitted by the remote control to acquire a control frequency corresponding to the target device in step S310. The control apparatus then utilizes the locating module to acquire a position information of the target device in step S320. Accordingly, the position information and the acquired control signal corresponding to the target device is recorded in the storage unit in step S330. Steps S310 to S330 are repeated if there are other target devices to be controlled by the control apparatus in step S340. As a result, a record of the position and a control signal corresponding to each target device is stored in the storage unit. For example, if the position information and the control frequency of the target devices Ti and T2 are recorded in the storage unit, there are two records R1 and R2 corresponding to the target devices T1 and T2 respectively in the storage unit. The position information of the target device T1 and the corresponding control frequency F1 are recorded in the record R1 while the position information of the target device T2 and the control frequency F2 corresponding thereto are recorded in the record R2. Thus, if the record (R2) comprising position information of target device T2 is located in the storage unit, the control frequency (F2) for controlling the corresponding target device T2 can be acquired from the same record (R2).

In other words, once the position information of a target device is found in the storage unit, the corresponding control frequency for controlling the target device is also obtained. It should be noted that the control signal, in this embodiment, may be the identification number of the physical remote control if the transmission unit is formed by a plurality of physical remote controls in which the identification number of each physical remote control is unique. In this case, once a specific target device is to be controlled, the button of the physical remote control corresponding to the identification number found is enabled to control the target device.

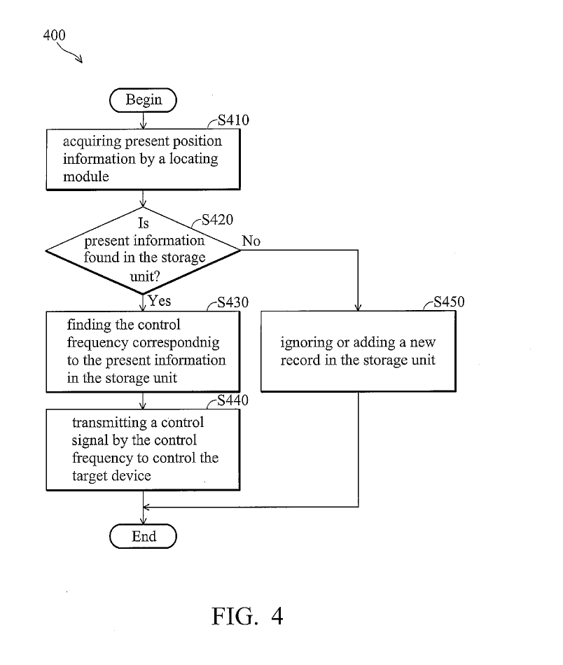

FIG. 4 is a flowchart of a control method for controlling the target device according to an embodiment of the invention. In step S410, the locating module of the control apparatus acquires the present position information of the target device when it is approached. The present position information is then compared to the records stored in a storage unit to determine whether a first record comprising the position information identical to the present position information can be found in step S420 If so, the control apparatus and the control frequency recorded in the same (first) record can control the corresponding target device. Proceeding to step S430, the control frequency corresponding to the target device is then obtained from the first record comprising position information same as the present position information in step S430. Accordingly, a control signal is transmitted by the obtained control frequency to control the target device in step S440. Thus, the target device is automatically controlled by the control signal without requiring manual intervention thus increasing convenience. If the first record comprising the position information identical to the present position information can not be found after all the records stored in the storage unit are compared, it is determined that the target device being approached can not yet be controlled by the control apparatus or the position information and corresponding control frequency of a target device have not yet been used and recorded. In the latter case, the present position information can be ignored, or a second record comprising the present position information and a control frequency corresponding thereto can be added to the storage unit by step S450 (steps S310 to S330). Thus, when the target device is approached again, the control apparatus can find a control frequency corresponding to the target device and transmits a control signal by the control frequency to control the target device.

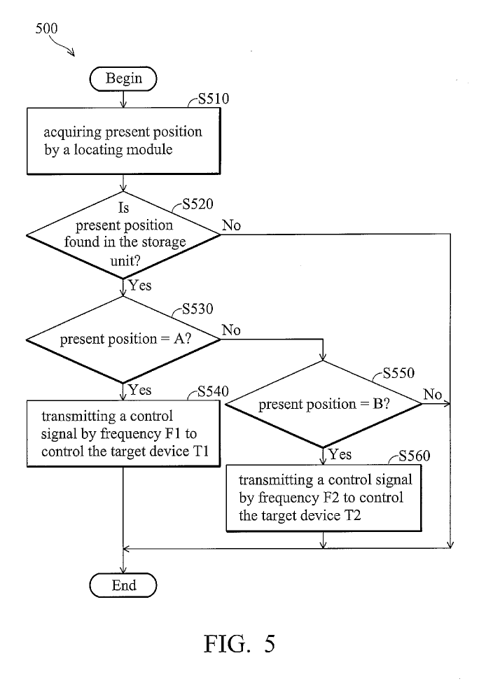

FIG. 5 is a flowchart of a control method for controlling the target device according to another embodiment of the invention. It is assumed that, in this embodiment, the control apparatus is a personal digital assistant (PDA) including a GPS signal-locating module, target device Ti is a security door, and target device T2 is a car. The target device Ti is positioned at position A and can be controlled by a first control signal transmitted by control frequency F1. The target device T2 is positioned at position B and can be controlled by a second control signal transmitted by control frequency F2. Initially (i.e. when first used), the positions A and B and the control frequencies F1 and F2 corresponding to the target devices T1 and T2 can be acquired and recorded in records R1 and R2 respectively by configuration steps S310 to S330. The contents (position information, control frequency) of the records R1 and R2 are respectively recorded as (A, F1) and (B, F2). In this embodiment, the position B of the target device T2 (i.e. a car) represents the location of the target device T2. As shown in FIG. 5, the GPS signal-locating module first acquires present position X in step S510. The records in the storage unit are checked to determine whether a first record that records a position same as the present position X can be found in step S520. If the first record is not found after all records in the storage unit are checked, it is determined that the target device being approached can not be controlled or the target device is not yet configured, thereby halting the process. If the present position X is found in one of the records R1 and R2, it is then determined whether the present position information X is equal to the position A in step S530. If so, the target device being approached is identified as the target device T1, that is, the security door, according to the position A. Thus, from the contents (A, F1) of the record R1, the control frequency corresponding to the security door (T1) is then found to be the control frequency F1. Accordingly, a control signal is transmitted by the control frequency F1 to the security door to control the security door, such as opening the security door in step S540. If the present position X is not equal to the position A, it is then determined whether the present position X is equal to the position B in step S540. If so, the target device is identified as the target device T2, that is, the car, according to the position B. Thus, from the contents (B, F2) of the record R2, the control frequency corresponding to the car (T2) is then determined be the control frequency F2. Accordingly, a control signal is transmitted by the control frequency F2 to the car to control the car, such as opening the car door in step S550.

In the invention, a target device can be automatically controlled later when it is approached again if the position and related control frequency thereof are configured and recorded in the storage unit in advance. Thus, no additional remote control is given for selecting and controlling the target device, improving convenience and remote control performance.

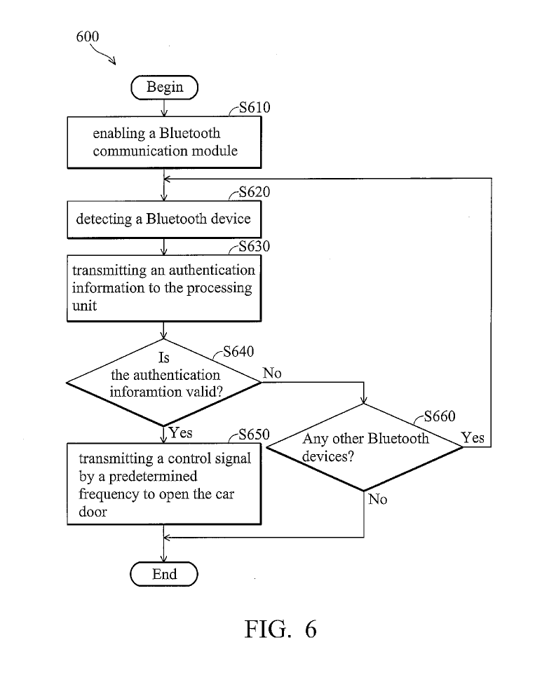

Moreover, the target device can also be automatically controlled by a wireless module for a target device without requiring a GPS locating module. In one embodiment, the wireless module may be a Bluetooth communication module capable of performing Bluetooth-based communication between two Bluetooth devices or a microwave module transmitting a specific frequency. The method as described in the following with reference to FIG. 6 is used for controlling the target device in which the target device and the control apparatus have Bluetooth communication modules.

FIG. 6 is a flowchart of a control method for controlling the target device according to yet another embodiment of the invention. In this embodiment, both the target device and the control apparatus comprise Bluetooth communication modules. In Bluetooth communication standard, devices having a Bluetooth communication module can detect and communicate with each other within a distance of about 20 meters. Thus, it can be determined that the target device is being approached if another device is detected by the Bluetooth communication module. Further, to identify a valid user, some authentication methods, such as specific authentication information or data, can be associated with the proposed method so that requests from other devices detected by unauthenticated Bluetooth communication modules can be ignored and avoided. It is assumed that, in this embodiment, the target device T is a car with a PDA including a Bluetooth communication module, and the control apparatus may be a PDA or a mobile telephone with the same Bluetooth communication module. In addition, the PDA comprises at least one processing unit. It is assumed that the Bluetooth communication module included in the PDA in the car is enabled such that a device with the same Bluetooth communication module can be automatically detected within a limited distance (i.e. 20 meters).

As shown in FIG. 6, if the control apparatus is a mobile telephone, the Bluetooth communication module included in the mobile telephone is first enabled in step S610. Next, since both the Bluetooth communication modules in the Bluetooth device (mobile telephone) and the car are enabled, the mobile telephone is detected by the PDA in the car when the Bluetooth device (mobile telephone) approaches to within a limited distance of the car in step S620. Thus, the processing unit of the PDA in the car sends an authentication request to the detected Bluetooth device (mobile telephone). After receiving the request, the Bluetooth device must transmit authentication information to the processing unit of the PDA within the car in step S630. The processing unit then determines whether the authentication information is valid in step S640. If so, the Bluetooth device (mobile telephone) is identified as a valid control apparatus as a user, and thus a control signal by a predetermined frequency is transmitted to control the car, such as opening the car door in step S650. In this embodiment, the predetermined frequency is the frequency that capable of opening the car door. If not, the Bluetooth device (mobile telephone) is identified as a no work control apparatus, and its authentication information is disregarded. It is then detected whether any other Bluetooth device is present in step S660. If so, steps S620 to S640 are repeated to determine whether any valid control apparatus is present. Control of the car (such as unlocking the car door) is prohibited unless a valid control apparatus with the valid authentication information is found. It should be noted that the authentication information may be any authentication data, such as a specific authentication number stored in first record of the address book in the mobile telephone or the PDA or a changed pin code, for verification. According to this embodiment of the invention, the car door can be unlocked automatically and safely as the method for unlocking the car door is unknown to others. Moreover, according to another embodiment of the invention, target devices in a fixed position, such as a security door, can also be controlled if a locating module if a PDA equipped with a GPS locating module is utilized.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A control method for automatically controlling a target device, the method comprising:
acquiring present position information according to a locating signal;
determining whether the target device is being approached by comparing the present position information and position information of the target device;
finding a control signal corresponding to the target device if the target device is being approached; and
controlling the target device by sending the control signal thereto.

2. The control method as claimed in claim 1, wherein the locating signal is generated by a GPS (global positioning system) signal locating module.

3. The control method as claimed in claim 1, wherein acquiring the present position information comprises the steps of:
searching the present position information from a plurality of records in a storage unit for acquiring the control signal corresponding thereto,
wherein the control signal is acquired if a first record corresponding to the present position information is found in the storage unit.

4. The control method as claimed in claim 3, further comprising:
adding a new record comprising the present position information and the control signal corresponding thereto to the storage unit if the first record is not found in the storage unit.

5. The control method as claimed in claim 1, wherein determining whether the target device is being approached further comprises the step of:
enabling a wireless module for detecting the target device,
wherein the target device is determined as being approached if the target device is detected by the wireless module.

6. The control method as claimed in claim 5, further comprising:
sending an authentication information to the target device if the target device is being approached;
determining whether the authentication information is valid; and
if so, informing a control apparatus and sending a predetermined control signal thereby for controlling the target device.

7. The control method as claimed in claim 6, further comprising:
ignoring the authentication information if the authentication information is not valid.

8. A control apparatus for controlling a target device, comprising:
a locating module for acquiring a present position information;
a processing unit for performing a comparison between the present position information and position information of the target device;
a storage unit for storing the position information of the target device and a control signal corresponding thereto; and
a transmission unit for sending the control signal to control the target device, wherein the processing unit drives the transmission unit to send the control signal to control the target device if a match between the present position information and the position information of the target device is found in the storage unit.

9. The control apparatus as claimed in claim 8, wherein the locating module is a GPS (global positioning system) signal locating module.

10. The control apparatus as claimed in claim 8, wherein the control apparatus is a PDA (personal digital assistant) including the GPS (global positioning system) signal locating module.

11. The control apparatus as claimed in claim 8, further comprising a wireless module for performing wireless communication with the target device, and sending authentication information to the target device for authentication.

12. The control apparatus as claimed in claim 8, further comprising a scanning module for scanning the control signal of the target device.

13. The control apparatus as claimed in claim 8, wherein the transmission unit is formed by a plurality of physical remote control.
